(19) United States
(12) Patent Application Publication
(10) Pub. No.: US 2008/0238602 A1
(43) Pub. Date: Oct. 2, 2008

(54) COMPONENTS WITH ON-DIE MAGNETIC CORES

(76) Inventors: GERHARD SCHROM, Hillsboro, OR (US); DONALD GARDNER, Mountain View, CA (US); PETER HAZUCHA, Beaverton, OR (US); FABRICE PAILLET, Hillsboro, OR (US); TANAY KARNIK, Portland, OR (US)

Correspondence Address: KACVINSKY LLC;C/O INTELLEVATE, P.O. BOX 52050, MINNEAPOLIS, MN, 55402, US

(21) Appl. No.: 11/694,796

(22) Filed: Mar. 30, 2007

(51) Int. Cl. H01F 10/08; H01F 27/28

(52) U.S. Cl. 336/84 M; 336/188; 336/200

(57) ABSTRACT

An apparatus may include a first magnetic layer, a second magnetic layer, and a conductive pattern. The conductive pattern is at a third layer between the first and second magnetic layers. Moreover, one or more magnetic vias connect the first and second magnetic layers. The magnetic layers and vias may operate as ferromagnetic cores or shields. Further they may be integrated on a chip (on-die magnetics). The apparatus may be included in inductors, transformers, transmission lines, and so forth.

### BACKGROUND

Electronic components, such as inductors, may be implemented on substrates such as an integrated circuit die or a printed circuit board (PCB). Such implementations involve placing patterns of material (e.g., as conductive material) on one or more substrate layers. This placement may be through lithographic techniques.

Inductors used for RF applications in complementary metal oxide semiconductor (CMOS) technology are typically air-core spiral inductors. Various drawbacks are associated with these inductors. For instance, air-core spiral inductors typically require a substantial amount of space (area) on a substrate (e.g., an IC die). Moreover, such inductors require a high-resistivity substrate.

### BRIEF DESCRIPTION OF THE DRAWINGS

FIGS. 1 and 2 are views of an inductor embodiment.

FIG. 3A is a top layout view of a symmetric spiral inductor.

FIG. 3B is a schematic of a balun circuit employing a symmetric spiral inductor.

FIG. 3C is a schematic of a combiner circuit employing a symmetric spiral inductor.

FIG. 4A is a top layout view of a 1:2 transformer circuit embodiment.

FIG. 4B is a schematic of a 1:2 transformer circuit.

FIG. 5A is a top layout view of a 1:1 transformer embodiment.

FIG. 5B is a schematic of a 1:1 transformer.

FIG. 6 is a top layout view of an inductor embodiment having a grounded magnetic core.

FIG. 7 is a top layout view of an inductor embodiment having an extended magnetic core.

FIG. 8 is a top layout view of a spiral inductor embodiment having an extended slotted magnetic core.

FIGS. 9A and 9B are views of a transmission line embodiment.

FIGS. 10A and 10B are views of a directional coupler embodiment.

### DETAILED DESCRIPTION

Various embodiments may be generally directed to techniques involving electronic components. For instance, in embodiments, an apparatus may include a first magnetic layer, a second magnetic layer, and a conductive pattern. The conductive pattern is at a third layer between the first and second magnetic layers. Moreover, one or more magnetic vias connect the first and second magnetic layers. In embodiments, the magnetic layers and vias may operate as ferromagnetic cores or shields. Further they may be integrated on a chip (on-die magnetics). Also, they may be implemented with CMOS technology or processes. The apparatus may be included in inductors, transformers, transmission lines, RF circuits, wireless applications, voltage regulators and so forth.

As described herein, embodiments may advantageously provide inductors of comparable or better performance than current ones, and that have a much smaller footprint. Further, embodiments avoid the blockage of space underneath inductors. Also, embodiments may be implemented with low-resistivity substrates. This allows, for example, co-integration of digital and RF circuits using a high-speed CMOS process.

Moreover, embodiments may provide inductors that may be used at lower frequencies. Exemplary lower frequency applications may include switching amplifiers used as envelope generators for high-efficiency RF power amplifiers. Such applications may involve modulation schemes requiring class-A linear RF power amplifiers, which have a theoretical efficiency of less than 12.5%. Other applications include resonant gate drivers for high-power DC-DC converters, low to mid-power on-die DC-DC converters.

The embodiments, however, are not limited to these applications or to inductors.

Embodiments may comprise one or more elements. An element may comprise any structure arranged to perform certain operations. Each element may be implemented with various technologies or processes, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

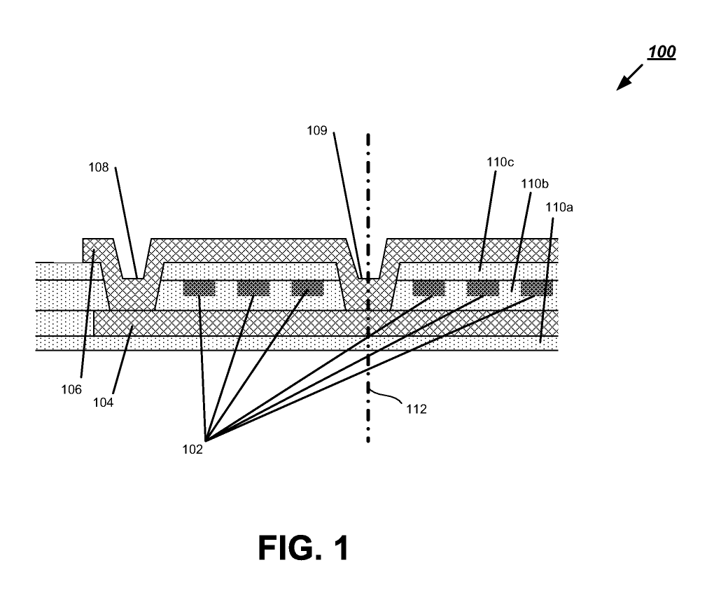

FIG. 1 is a side cross-section view of an inductor embodiment 100. As shown in FIG. 1, inductor 100 includes an inductor winding 102, a first magnetic layer 104, and a second magnetic layer 106. In addition, inductor 100 includes multiple magnetic vias (a via 108 and a via 109). Moreover, inductor 100 includes a first insulating layer 110a, a second insulating layer 110b, and a third insulating layer 110c.

Thus, FIG. 1 shows multiple layers arranged along an axis 112. These layers are arranged in the following order: first insulating layer 110a, first magnetic layer 104, second insulating layer 110b, third insulating layer 110c, and second magnetic layer 106. The embodiments, however, are not limited to this context. For instance, embodiments may include additional (e.g., intermediate) layers.

Winding 102 may comprise a layer of metal on or in insulating layer 110b. This metal may be a suitable inductor material, such as copper. The embodiments, however, are not limited to this example. Through techniques (e.g., lithography), winding 102 may be configured as a wire arranged in a pattern, such as a spiral.

Winding 102 is arranged between first magnetic layer 104 and second magnetic layer 106. Also, magnetic layers 104 and 106 are shown to be physically connected. This connection is provided by magnetic vias 108 and 109, which include openings in insulating layers 110b and 110c. Thus, magnetic layers 104 and 106, as well as magnetic vias 108 and 109, form a magnetic core. Magnetic layers 104 and 106, as well as magnetic vias 108 and 109, are composed of a ferromagnetic material.

Although not shown, inductor 100 may further include a magnetic shield formed by a layer of ferromagnetic material. This shield may be relatively thin, and may be placed underneath winding 102 and magnetic core of inductor 100.

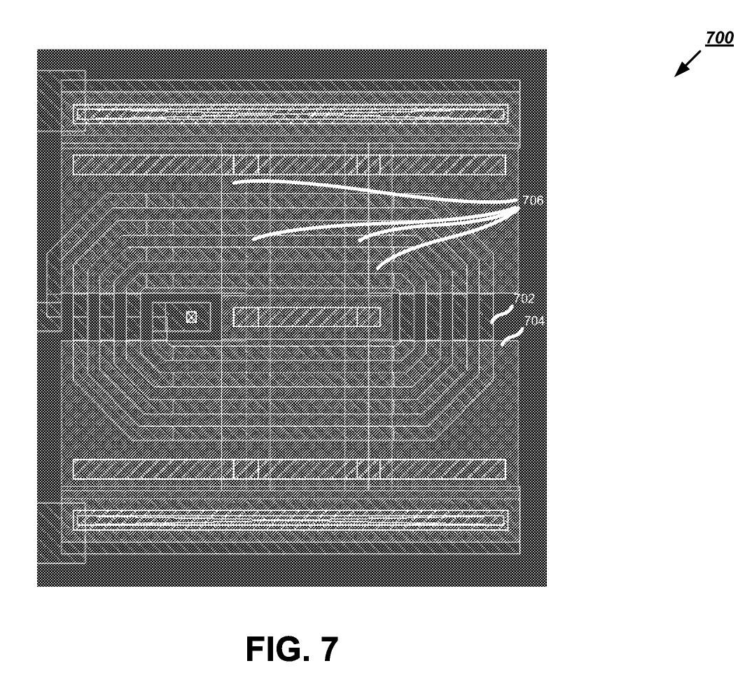

Alternatively, a magnetic shield may be placed underneath winding 102 in the areas not having a magnetic core. This may be implemented, for example, by enlarging first magnetic layer 104 (but not second magnetic layer 106) to be under all (or substantially all of) winding 102. An example of this feature is shown in FIG. 7.

Such an implementation shields circuits underneath inductor 100 from most of it associated magnetic field(s), while leaving more than half of the air-core inductance intact. Thus, this feature may strike a compromise between having a full magnetic core and no core at all for particular areas of winding 102.

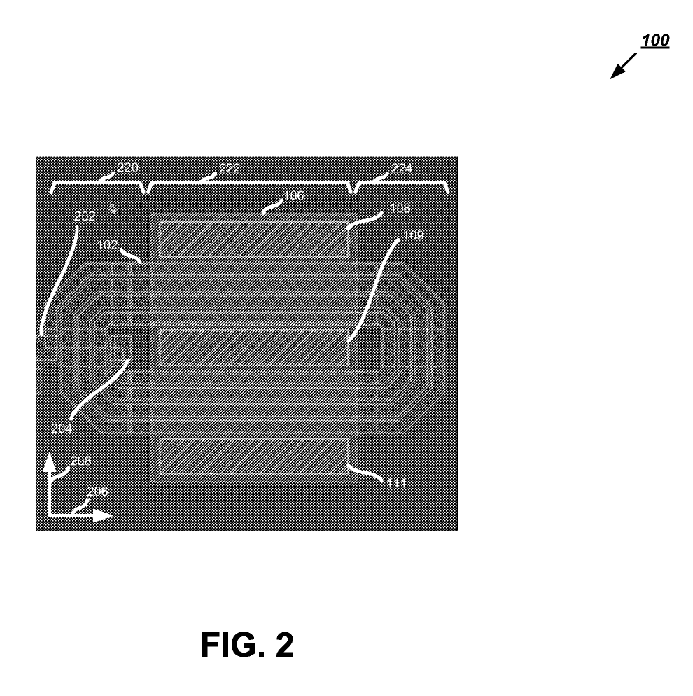

FIG. 2 is a top layout view of inductor embodiment 100. First magnetic layer 104 is not included in this view. However, first magnetic layer 104 (which is positioned below winding 102) may have substantially the same footprint as second magnetic layer 106. This view shows winding 102 arranged in a spiral pattern between a first terminal 202 and a second terminal 204. In addition, this view shows inductor 100 having a further via 111.

As shown in FIG. 2, vias 108, 109, and 111 are placed along sides of the inductor wires (winding 102). Such placement of vias reduces or closes air-gaps between the magnetic layers 104 and 106. As a result, a relatively low reluctance, as seen by an associated magnetic field is achieved. Correspondingly, a relatively high inductance is attained.

Vias 108 and 111 each have one side that is adjacent to winding 102, while via 109 has two sides that are adjacent to winding 102. Thus, via 109 is referred to as a “shared via” and vias 108 and 111 are referred to as “unshared vias.” The employment of shared vias (e.g., in the center of winding 102) may save space. Depending on implementations, such savings may be on the order of several tens of micrometers. Also, shared vias may reduce winding resistance (e.g., reduce the resistance of winding 102).

In embodiments, shared vias can be the same size as unshared vias. Alternatively, shared vias may be wider. A wider width may prevent saturation at lower currents. However, the widening of shared vias is typically not required. This is because unwidened shared vias (e.g., at the size of corresponding unshared vias) are usually wider than the characteristic distance for the lateral decay of the magnetic field.

FIG. 2 shows a first direction 206 and a second, orthogonal, direction 208. Winding 102 is arranged such that it is longer in first direction 206 than in second direction 208. Also, magnetic layers 104 and 106 (as well as of magnetic vias 108, 109, and 111) may be composed of magnetic material having soft axes that are substantially aligned with first direction 206. Thus, the hard axes of the magnetic material are advantageously aligned with most of the magnetic field from winding 102

Magnetic layer 104 and/or magnetic layer 106 may not completely overlay winding 102. For instance, FIG. 2 shows an overlapping area 222, as well as non-overlapping areas 220 and 224. Through such an arrangement, portions of inductor 100 operate like an air core inductor. This feature may mitigate (or even prevent) a drop of the inductor's quality factor due to eddy currents at high frequencies.

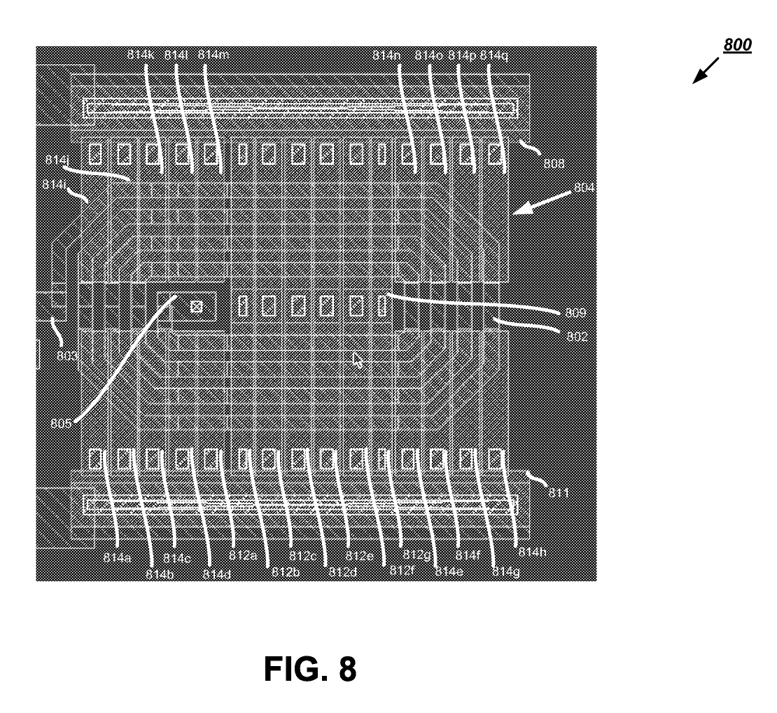

Moreover, in embodiments, magnetic core is placed only in (or mostly in) areas where windings or wires are not perpendicular to the soft axis of the magnetic core. This avoids reductions in inductance. This is because the relative permeability is approximately 1.0 in areas where the wires or winding would be perpendicular to the core's soft axis. As a result, avoiding placement of the conductive core in such areas prevents further eddy current losses. This feature is shown, for example, in FIG. 2. A further example of this feature is shown in FIG. 8.

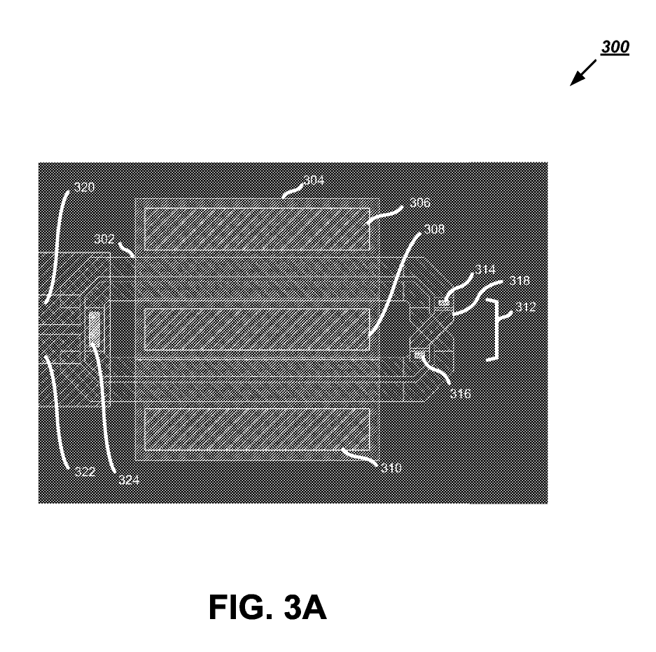

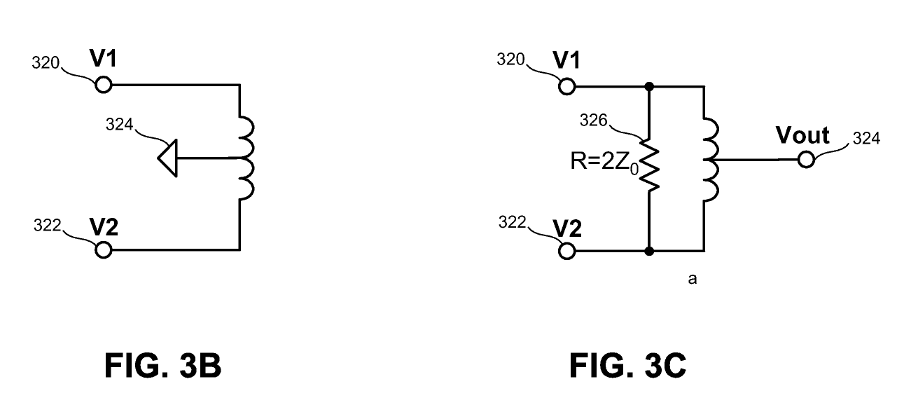

FIGS. 1 and 2 are provided as examples, and not as limitations. Further exemplary embodiments employing similar techniques are provided below with reference to FIGS. 3A through 10. However, the embodiments are not limited to these illustrated and described examples.

FIG. 3A is a top layout view of a symmetric spiral inductor 300 with a center tap. As shown in FIG. 3A, spiral inductor 300 includes a winding 302, a top magnetic layer 304, as well as vias 306, 308, and 310. Although not shown, spiral inductor 300 includes a bottom magnetic layer (similar to first magnetic layer 104). This bottom magnetic layer (which may be below winding 302) may have substantially the same footprint as top magnetic layer 304. The components of FIG. 3A may be implemented in the manner described above with reference to FIGS. 1 and 2.

However, winding 302 includes a cross-over 3 12. As shown in FIG. 3A, this cross-over is implemented with vias 314 and 316. These vias, provide for a portion 318 connected to winding 302 to be placed at a different layer.

FIG. 3A shows inductor 300 having a first terminal 320, a second terminal 322, and a center tap 324. Through these features, inductor 300 may be used in various circuits, examples of which are shown in FIGS. 3B and 3C.

For instance, FIG. 3B is a schematic of a balun circuit employing symmetric spiral inductor 300. In this circuit, a voltage signal V1 is at first terminal 320, a voltage signal V2 is at second terminal 322, and center tap 324 is grounded. In embodiments V1 may equal −V2.

FIG. 3C is a schematic of a combiner circuit employing symmetric spiral inductor 300. In this circuit, a voltage signal V1 is at first terminal 320, and a voltage signal V2 is at second terminal 322. However, center tap 324 provides an output voltage signal Vout. Also, FIG. 3C shows a resistance 326 coupled between terminals 320 and 322. This resistance (shown having a value of 2Z₀) may be implemented with a printed resistance (e.g., a dielectric material).

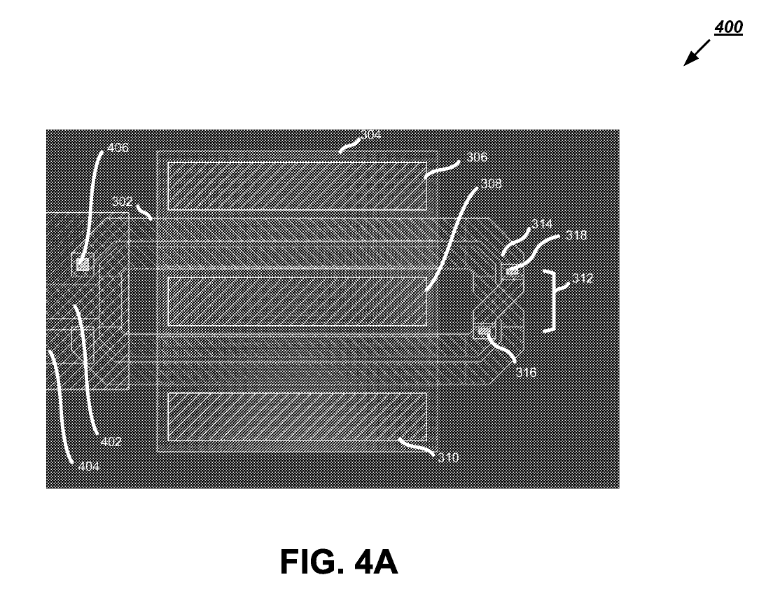

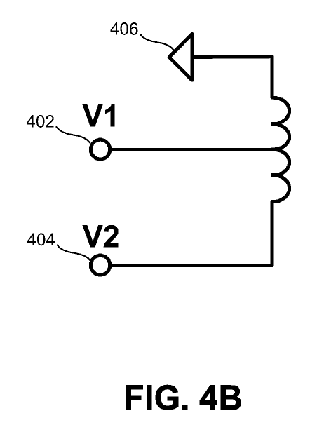

FIG. 4A is a top layout view of a 1:2 transformer circuit embodiment 400. This circuit is very similar to the circuit 300 of FIG. 3A. However, circuit 400 comprises a center tap terminal 402, a terminal 404, and a grounded terminal 406. A schematic of circuit 400 is shown in FIG. 4B. This schematic shows a voltage signal V1 at center tap terminal 402, and a voltage signal V2 at terminal 404. The following relationship may exist among these voltage signals: V2=2(V1).

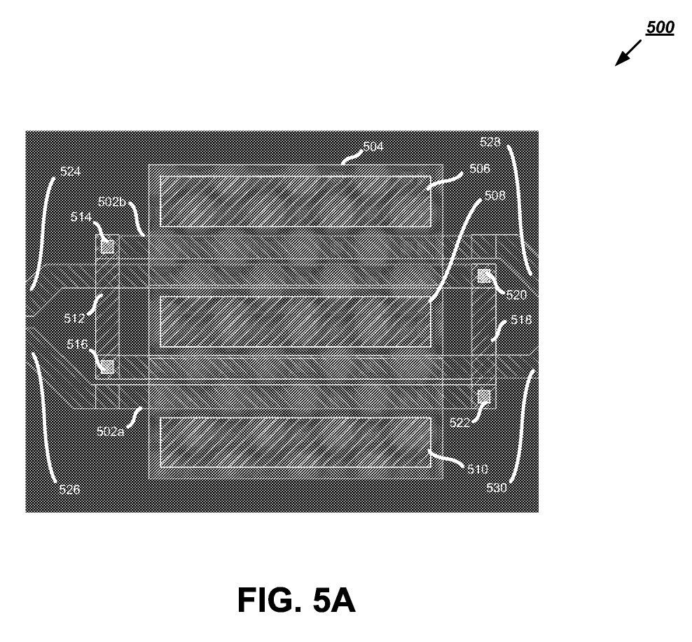

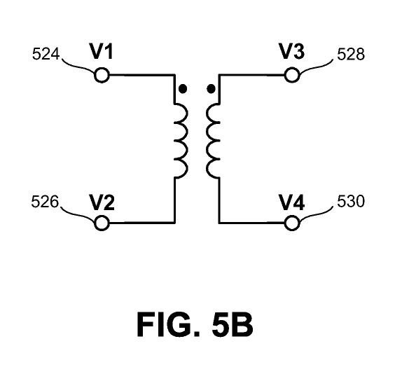

FIG. 5A is a top layout view of a 1:1 transformer 500. This view shows transformer 500 having a winding 502a, a winding 502b, and a top magnetic layer 504. In addition, transformer 500 includes vias 506, 508, and 510. Although not shown, transformer 500 includes a bottom magnetic layer (similar to first magnetic layer 104). This bottom magnetic layer (which may be below windings 502a and 502b) may have substantially the same footprint as top magnetic layer 504. The components of FIG. 5A may be implemented in the manner described above with reference to FIGS. 1 and 2.

However, winding 502a and 502b are connected to cross-over portions 514 and 512, respectively. As shown in FIG. 5A, vias 514 and 516 allow cross-over portion 512 to be placed at a different layer. Likewise, vias 520 and 522 allow cross-over portion 518 to be placed at a different layer.

FIG. 5A further shows transformer 500 having a first terminal 524, a second terminal 526, a third terminal 528, and a fourth terminal 530. A schematic of transformer 500 is provided in FIG. 5B. This schematic shows a voltage signal V1 at first terminal 524 and a voltage signal V2 at second terminal 526. Further, FIG. 5B shows a voltage signal V3 at third terminal 528, and a voltage signal V4 at fourth terminal 530. The following relationship may exist among these voltage signals: V1-V2=V3-V4.

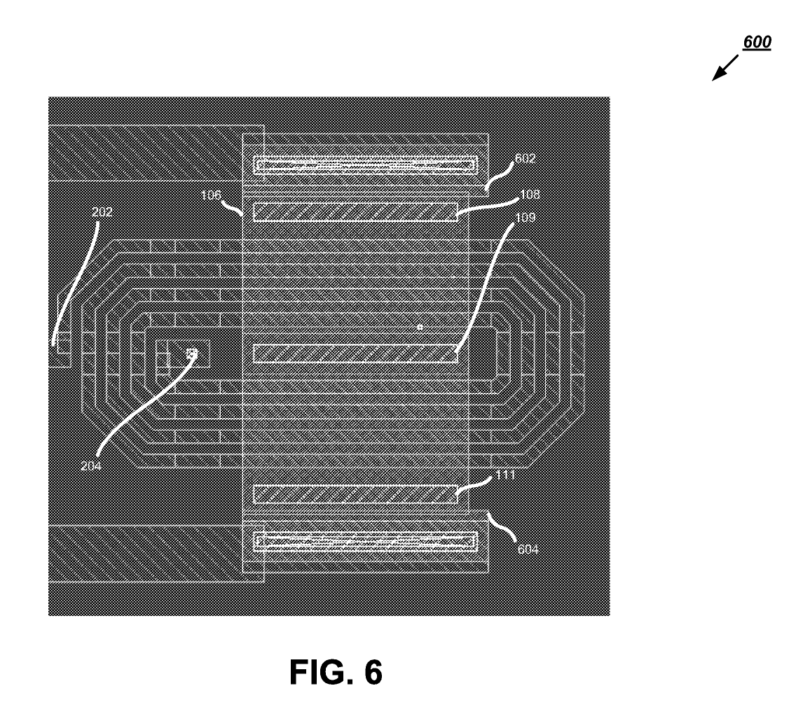

FIG. 6 is a top layout view of an inductor 600 that is similar to inductor 100. However, the magnetic core of inductor 600 is grounded. As shown in FIG. 6, grounding connections 602 and 604 are coupled to magnetic layer 106. Although not shown, magnetic layer 104 may be similarly grounded. The embodiments, however, are not limited to the depicted grouding technique. In fact, other ground connections and/or techniques may be employed.

FIG. 7 is a top layout view of an inductor 700, which may be layered in the manner of FIG. 1. Inductor 700 has an extended magnetic core, as shown by a bottom magnetic layer 704, which extends beyond areas of a winding 702 that are covered by a top magnetic layer 706. As shown in FIG. 7, bottom magnetic layer 704 (and thus the extended core) covers portions of winding 702 having substantially 45 degree angles. Alternatively, a magnetic shield can be placed underneath winding 702 instead of such core extensions. A bottom magnetic layer is not included in this view. However, such a bottom magnetic layer (which is arranged underneath winding 702) may have substantially the same footprint as first magnetic layer 704.

FIG. 8 is a top layout view of a spiral inductor 800 employing an extended slotted magnetic core. As shown in FIG. 8, spiral inductor 800 includes a winding 802, a top magnetic layer 804, as well as vias 808, 809, and 811. FIG. 8 further shows winding 802 having terminals 803 and 805. Although not shown, spiral inductor 800 includes a bottom magnetic layer (similar to first magnetic layer 104). This bottom magnetic layer (which may be below winding 802) may have substantially the same footprint as top magnetic layer 804. The components of FIG. 8 may be implemented in the manner described above with reference to FIGS. 1 and 2.

However, magnetic layer 804 and the bottom magnetic layer may be arranged to form a slotted core. For instance, FIG. 8 shows magnetic layer 804 having multiple members 812 and 814 that are spaced to provide slotted openings between them. As shown in FIG. 8, slotted magnetic layer 804 covers portions of winding 802 at 45 degree angles. In embodiments, the slots provided by the magnetic core are substantially perpendicular to the soft axis of the magnetic material.

Slotting a magnetic core or shield (e.g., as shown in FIG. 8) helps reduce eddy currents in the corresponding magnetic material. Moreover, keeping the slots in the directions of high permeability avoids a reduction of the inductance. Thus, embodiments, such as the various ones disclosed herein, may introduce slots to magnetic cores and/or shields. Such slots may be substantially perpendicular to the easy axis regardless of the direction of windings, wires, and/or lines.

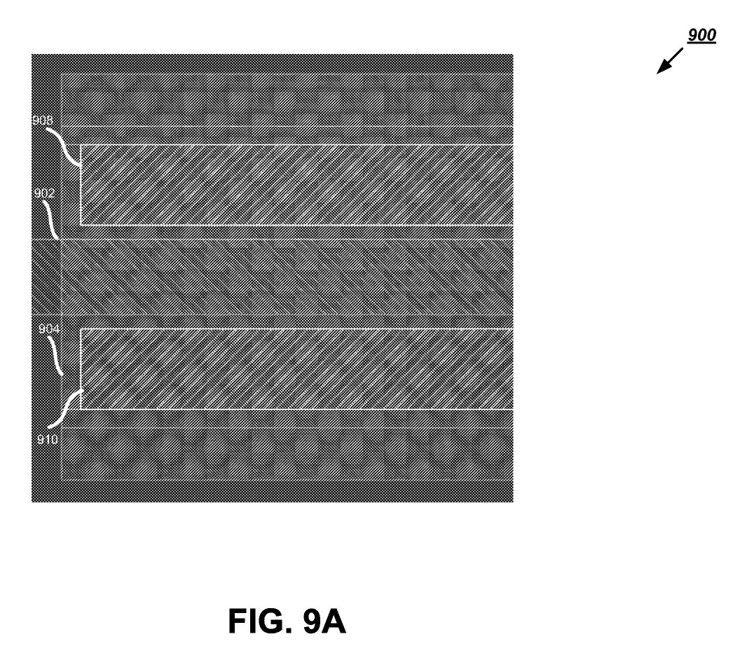

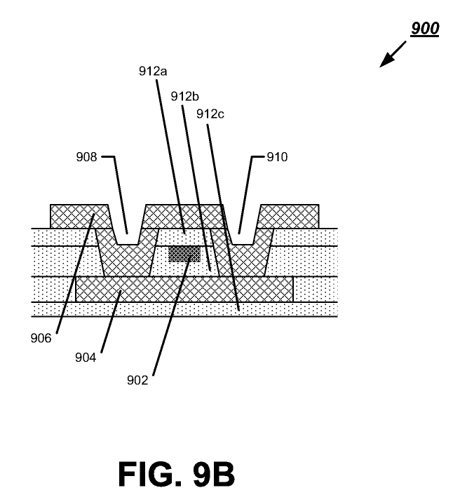

In addition to the above examples, embodiments of the present invention may involve transmission lines. For example, FIG. 9A is a top layout view of a transmission line embodiment 900 (showing only one end). Transmission line 900 is implemented similar to the embodiments described above. In this embodiment, conductor (e.g., line) 902 is between a first via 908 and a second via 910. These vias connect a first magnetic layer 904 and a second magnetic layer 906, thereby forming a magnetic core. In embodiments, this magnetic core may be grounded. FIG. 9B is a side cutaway view of transmission line 900. In this view, line 902, magnetic layer 904, and magnetic layer 906 are shown among insulating layers 912a, 912b, and 912c.

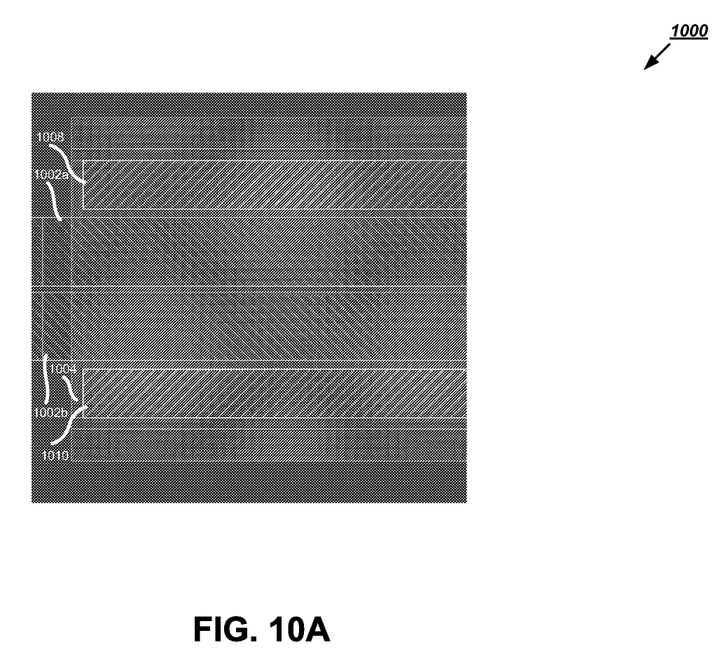

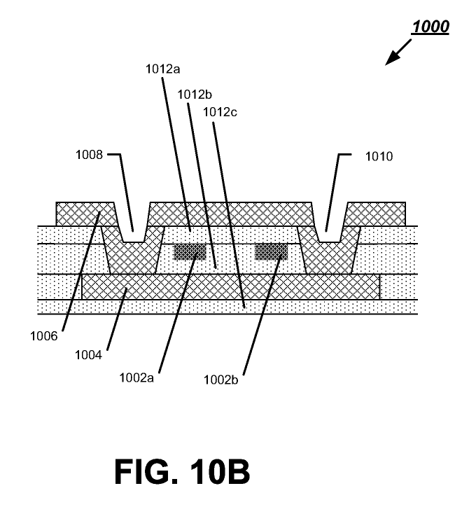

Similarly, FIG. 10A is a top layout view of a directional coupler embodiment 1000 (showing only one end). Directional coupler 1000 is implemented similar to the transmission line of FIGS. 9A and 9B. In this embodiment, a first conductor or line 1002a and a second conductor or line 1002b are between a first via 1008 and a second via 1010. These vias connect a first magnetic layer 1004 and a second magnetic layer 1006, thereby forming a magnetic core. In embodiments, this magnetic core may be grounded. A side cutaway view of directional coupler 1000 is shown in FIG. 10B. In this view, lines 1002a and 1002b, magnetic layer 1004, and magnetic layer 1006 are shown among insulating layers 1012a, 1012b, and 1012c.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a first magnetic layer;
a second magnetic layer;
a conductive pattern at a third layer between the first and second magnetic layers; and
one or more magnetic vias connecting the first and second magnetic layers.

2. The apparatus of claim 1, wherein the conductive pattern is a spiral winding.

3. The apparatus of claim 2:
wherein the spiral winding is longer is a first direction than in a second, orthogonal, direction; and
wherein the first magnetic layer, the second magnetic layer, and the one or more magnetic vias are each composed of magnetic material having soft axes that are substantially aligned with first direction.

4. The apparatus of claim 2, wherein the spiral winding includes a cross-over.

5. The apparatus of claim 1, wherein the one or more magnetic vias includes a first magnetic via at a center portion of the spiral winding.

6. The apparatus of claim 1, wherein the one or more magnetic vias includes a second magnetic via at a first side portion of the spiral winding and a third magnetic via arranged at a second side portion of the spiral winding, wherein the first side portion is opposite to the second side portion.

7. The apparatus of claim 1:
wherein the first and second magnetic layers each include multiple slot openings; and
wherein the first magnetic layer, the second magnetic layer, and the one or more magnetic vias are each composed of magnetic material having soft axes that are substantially perpendicular with the slot openings.

8. The apparatus of claim 1, further comprising a magnetic shield, wherein the first magnetic layer forms the magnetic shield.

9. The apparatus of claim 1, wherein the magnetic shield is located under one or more portions of the conductive pattern that are not covered by the second magnetic layer.

10. The apparatus of claim 1, wherein the first magnetic layer extends beyond areas covered by the second magnetic layer.

11. The apparatus of claim 1, wherein the first magnetic layer, the second magnetic layer, and the one or more magnetic vias are grounded.

12. The apparatus of claim 1, wherein the conductive pattern includes a first winding and a second winding, wherein the first and second windings overlap.

13. The apparatus of claim 1, wherein the overlapping of the first and second windings are provided by a first cross-over connected to the first winding and a second cross-over connected to the second winding.

14. The apparatus of claim 1, further comprising an integrated circuit (IC) die, wherein the IC die includes the first magnetic layer, the second magnetic layer, the conductive pattern, and the one or more magnetic vias.

15. The apparatus of claim 14, wherein the IC die is a complementary metal oxide semiconductor (CMOS) die.

16. The apparatus of claim 1, wherein the first magnetic layer, the second magnetic layer, the conductive pattern, and the one or more magnetic vias are included in an inductor.

17. The apparatus of claim 1, wherein the first magnetic layer, the second magnetic layer, the conductive pattern, and the one or more magnetic vias are included in a radio frequency (RF) circuit.

18. The apparatus of claim 1, wherein the first magnetic layer, the second magnetic layer, the conductive pattern, and the one or more magnetic vias are included in a transformer.
